(19) United States
(12) Patent Application Publication
(10) Pub. No.: US 2015/0097822 A1
(43) Pub. Date: Apr. 9, 2015

(54) LIGHT EMITTING DEVICE, ELECTRONIC APPARATUS, AND DESIGN METHOD OF SEMICONDUCTOR DEVICE

(71) Applicant: Seiko Epson Corporation, Tokyo (JP)

(72) Inventor: Hitoshi OTA, Shiojiri-shi (JP)

(21) Appl. No.: 14/495,672

(22) Filed: Sep. 24, 2014

(30) Foreign Application Priority Data
Oct. 9, 2013 (JP) 2013-211673

(51) Int. Cl. G09G 3/32

(52) U.S. Cl. CPC G09G 3/3291
USPC 345/211; 345/82

(57) ABSTRACT

A light emitting device including a drive transistor that generates a drive current of a current amount corresponding to a gate-source voltage, a light emitting element that emits light at a luminance corresponding to the current amount of the drive current, and a control unit that controls the gate-source voltage according to a specified gradation is configured as follows. The gate-source voltage is a voltage of a first voltage value or more and a second voltage value or less. The first voltage value and the second voltage value are set such that a change minimum voltage value is a gate-source voltage when a change rate of the drive current with respect to an environmental temperature change is a predetermined value or less and is included between the first voltage value and the second voltage value.

### BACKGROUND

1. Technical Field

The present invention relates to a light emitting device, an electronic apparatus, and a design method of a semiconductor device.

2. Related Art

Various light emitting devices using a light emitting element such as an Electro-Luminescence (EL) element have been proposed. In such a light emitting device, a drive current that is supplied to the light emitting element is controlled by using a drive transistor. A data signal of the potential corresponding to the gradation level of the luminance of the light emission is applied to the gate of the drive transistor. The drive transistor, to the gate of which the data signal is applied, supplies a current (drive current) corresponding to a potential difference between a gate and a source (hereinafter, simply referred to as a “gate-source voltage”) to the light emitting element. Then, the light emitting element emits light at a luminance of the gradation level corresponding to the supplied drive current.

Accordingly, in the driving of the light emitting device using the light emitting element, it is important to accurately control the drive current supplied to the light emitting element. JP-A-2013-088611 discloses a technology of accurately controlling the drive current to be supplied to the light emitting element, without the need for a precise and accurate data signal.

In an electro-optical device disclosed in JP-A-2013-088611, a data signal is not directly written into the gate of a drive transistor, the data signal after it has been multiplied by a predetermined coefficient and level-shifted is written into the gate of the drive transistor. Since the potential range of the gate is compressed to 1/10 of the potential range of the data signal due to the level shift, it is possible to apply a voltage that reflects the gradation level between the gate and source of the drive transistor, even if the data signal is not finely divided. The paragraphs 0036 to 0040 of JP-A-2013-088611 describe that the drive current supplied to the light emitting element is accurately controlled by such a process.

However, a characteristic showing a relationship between the gate-source voltage of a transistor and a current flown by the gate-source voltage (hereinafter, simply referred to as “voltage-current characteristic”) is affected by an environmental temperature. The environmental temperature is the temperature of the vicinity of a position at which the transistor is disposed.

Therefore, even when the same gate-source voltage is applied, if the environmental temperature changes, the drive current supplied to the light emitting element changes, and the luminance of the light emission changes as a result.

Particularly, in an apparatus configured such that the gradation is divided with a fine drive current range, such as, for example, micro displays (compact displays which are smaller than one inch with a resolution of 1280×720 pixels or more), the drive current greatly changes due to a slight change in the gate-source voltage. Therefore, in the apparatus configured such that the gradation is divided with a fine drive current range, the light emission luminance change due to the environmental temperature change becomes great. Further, a technology disclosed in JP-A-2013-088611 has not considered the problems caused by the environmental temperature change.

### SUMMARY

An advantage of some aspects of the invention is to provide a light emitting device, an electronic apparatus, and a design method of a semiconductor device, in which the light emission luminance change due to the environmental temperature change is suppressed.

In order to solve the above problems, a light emitting device according to an aspect of the invention includes a drive transistor that generates a drive current of a current amount corresponding to a gate-source voltage; a light emitting element that emits light at a luminance corresponding to the current amount of the drive current; and a control unit that controls the gate-source voltage according to a specified gradation, in which the gate-source voltage is a first voltage value or more at which the light emitting element emits light at a luminance corresponding to a first gradation and a second voltage value or less at which the light emitting element emits light at a luminance corresponding to a second gradation, and in which the first voltage value and the second voltage value are set such that a third voltage value, which is a gate-source voltage when a change rate of the drive current with respect to an environmental temperature change is a predetermined value or less, is included between the first voltage value and the second voltage value.

Here, the third voltage value may be the gate-source voltage when the change rate is at a minimum.

According to the aspect, the voltage range of the gate-source voltage which is defined by a first voltage value at which light is emitted at a luminance corresponding to a minimum gradation and a second voltage value at which light is emitted at a luminance corresponding to a maximum gradation is set to include the third voltage value. Here, the third voltage value is a gate-source voltage when the change rate is at a minimum (when the change in the drive current with respect to the environmental temperature change hardly occurs). According to the third voltage value, substantially the same drive current can be obtained, regardless of the environmental temperature change, and as the gate-source voltage is closer to the third voltage value, the change in the drive current with respect to the environmental temperature change is small, but the voltage range of the gate-source voltage is set to include the third voltage value, and thus the change in the drive current due to the environmental temperature change is suppressed and the change in the light emission luminance is suppressed.

In the light emitting device according to the aspect of the invention, the drive transistor is made of single crystal silicon or pseudo single crystal silicon. According to the aspect, in the drive transistor, a first characteristic curve representing a voltage-current characteristic at a time of a specific environmental temperature (referred to as a first temperature) intersects with a second characteristic curve representing a voltage-current characteristic at a time of a second temperature different from the first temperature. In other words, substantially the same drive current can be obtained at the specific gate-source voltage, regardless of the environmental temperature. That is because the drive transistor manufactured on a semiconductor substrate made of single crystal silicon or pseudo single crystal silicon has two characteristic areas in which the characteristics of the current change with respect to the environmental temperature change are different from each other with the specific gate-source voltage as a reference. One characteristic area out of the two characteristic areas is a first characteristic area in which the current increases with an increase of the environmental temperature, and the other characteristic area is a second characteristic area in which the current decreases with the increase of the environmental temperature.

In the light emitting device according to the aspect of the invention described above, the first voltage value and the second voltage value may be set such that the third voltage value is a voltage value at which the light emitting element emits light at a luminance corresponding to an intermediate gradation between the first gradation and the second gradation. According to the aspect, even when the environmental temperature changes, variation is hardly generated in the luminance corresponding to the intermediate gradation between the minimum gradation and the maximum gradation, and thus visibility is greatly improved.

In the light emitting device according to the aspect of the invention described above, the first voltage value and the second voltage value may be set such that the third voltage value is a voltage value at which the light emitting element emits light at a luminance corresponding to a maximum gradation. According to the aspect, even when the environmental temperature changes, variation is hardly generated in the luminance corresponding to the maximum gradation, and thus visibility is greatly improved.

In the light emitting device according to the aspect of the invention described above, the drive transistor may be a P-type transistor, and a thickness of a gate oxide film may be 10 nm or more and 30 nm or less, the first voltage value and the second voltage value may be set such that the third voltage value is a voltage value of −1.55 V or more and −1.3 V or less. In the light emitting device according to the aspect of the invention described above, the drive transistor may be an N-type transistor, and a thickness of a gate oxide film may be 10 nm or more and 30 nm or less, the first voltage value and the second voltage value are may be set such that the third voltage value is a voltage value of 1.3 V or more and 1.55 V or less. According to the aspect, the change in the drive current IDR due to the environmental temperature change is suppressed, and thus the change in the light emission luminance due to the environmental temperature change is suppressed.

Further, an electronic apparatus according to another aspect of the invention includes the light emitting device according to the aspects of the invention described above. Examples of such an electronic apparatus include digital cameras, video cameras, head mounted displays, personal computers, and the like.

In order to solve the above problems, a design method of a semiconductor device according to a still another aspect of the invention is a design method of a semiconductor device including a drive transistor that generates a drive current of a current amount corresponding to a gate-source voltage, a light emitting element that emits light at a luminance corresponding to the current amount of the drive current, and a control unit that controls the gate-source voltage according to a specified gradation, the method includes specifying a characteristic when an environmental temperature is a first temperature; specifying the characteristic when the environmental temperature is a second temperature; specifying a third voltage value which is a gate-source voltage when a change rate of the drive current with respect to an environmental temperature change is a predetermined value or less, based on the characteristic at a time of the first temperature and the characteristic at a time of the second temperature; and setting a first voltage value and a second voltage value such that the third voltage value is included between the first voltage value which is the gate-source voltage at which the light emitting element emits light at a luminance corresponding to a minimum gradation and the second voltage value which is the gate-source voltage at which the light emitting element emits light at a luminance corresponding to a maximum gradation.

According to the aspect, the voltage range of the gate-source voltage which is defined by a first voltage value at which light is emitted at a luminance corresponding to a minimum gradation and a second voltage value at which light is emitted at a luminance corresponding to a maximum gradation is set to include the third voltage value. Here, the third voltage value is a gate-source voltage when the change rate is at a minimum (when the change in the drive current with respect to the environmental temperature change hardly occurs). According to the third voltage value, substantially the same drive current can be obtained, regardless of the environmental temperature change, and as the gate-source voltage is closer to the third voltage value, the change in the drive current with respect to the environmental temperature change is small, but the voltage range of the gate-source voltage is set to include the third voltage value, and thus the change in the drive current due to the environmental temperature change is suppressed and the change in the light emission luminance is suppressed.

### BRIEF DESCRIPTION OF THE DRAWINGS

The invention will be described with reference to the accompanying drawings, wherein like numbers reference like elements.

FIG. 1 is a block diagram illustrating a configuration example of a light emitting device (display device) according to an embodiment of the invention.

FIG. 2 is a diagram illustrating a wave form of each part of the light emitting device according to an embodiment of the invention.

FIG. 3 is a circuit diagram illustrating an example of a pixel circuit included in the light emitting device according to an embodiment of the invention.

FIG. 4 is a diagram illustrating a curve representing a relationship between a gate-source voltage of a drive transistor and a drive current, and a curve representing a relationship between the gate-source voltage of the drive transistor and the change ratio of the drive current due to an environmental temperature change.

FIG. 5 is a diagram illustrating a relationship between a thickness [angstrom] of a gate oxide film and a change minimum voltage VGSm.

FIG. 6 is a diagram illustrating an enlarged view of the vicinity of a change minimum point Pm in the graph illustrated in FIG. 4.

FIG. 7 is a diagram illustrating a modification example according to a setting mode of a first voltage value and a second voltage value (voltage range ΔV).

FIG. 8 is a diagram illustrating a modification example according to a setting mode of a first voltage value and a second voltage value (voltage range ΔV).

FIG. 9 is an external diagram illustrating a configuration example of a digital camera including an EVF to which the light emitting device according to an embodiment of the invention is applied.

FIG. 10 is an external diagram illustrating a configuration example of a HMD to which the light emitting device according to an embodiment of the invention is applied.

FIG. 11 is a diagram illustrating an optical configuration of the HMD illustrated in FIG. 10.

FIG. 12 is a perspective view illustrating an appearance of a personal computer to which the light emitting device according to an embodiment of the invention is applied.

### DESCRIPTION OF EXEMPLARY EMBODIMENTS

### A: Embodiment

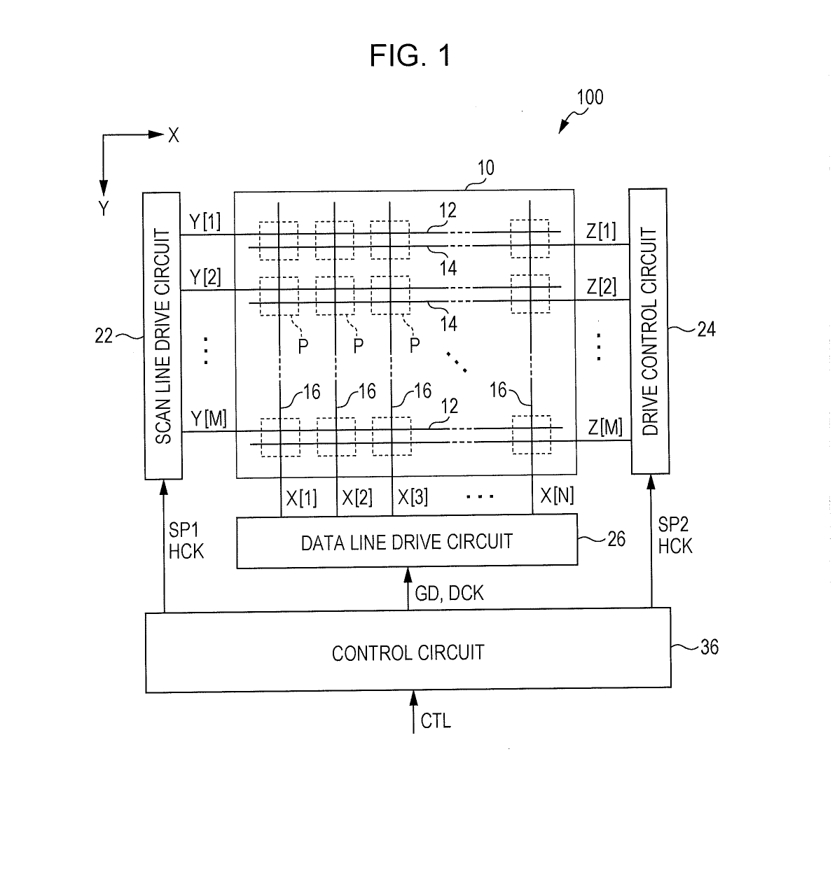

FIG. 1 is a block diagram illustrating a configuration example of a light emitting device (display device) according to an embodiment of the invention. As illustrated in FIG. 1, the light emitting device 100 includes an element array unit 10 in which a plurality of pixel circuits P are arranged, a scan line drive circuit 22, a drive control circuit 24, a data line drive circuit 26 and a control circuit 36. It is preferable that the components be formed on the same substrate. Further, it is preferable that the substrate be made of a semiconductor substrate.

However, a control signal CTL for controlling the scan line drive circuit 22, the drive control circuit 24, and the data line drive circuit 26 is supplied to the light emitting device 100 from the outside.

In the element array unit 10, M scan lines 12 extending in an X direction, M drive control lines 14 which form pairs with the respective scan lines 12 and extend in the X direction, and N data lines 16 extending in a Y direction intersecting with the X direction are formed (each of M and M is two or more natural numbers). Each pixel circuit P is located corresponding to each intersection of the scan line 12 and the data line 16. Accordingly, the pixel circuits P in a matrix shape having vertical M rows and horizontal N columns are arranged over the X direction and the Y direction in the entirety of the element array unit 10.

The scan line drive circuit 22 corresponds to a unit that generates scan signals Y[1] to Y[M] for sequentially selecting each of the M scan lines 12 (pixel circuit P in each row) and outputting the created scan signals to each scan line 12 (for example, a shift register of M bits).

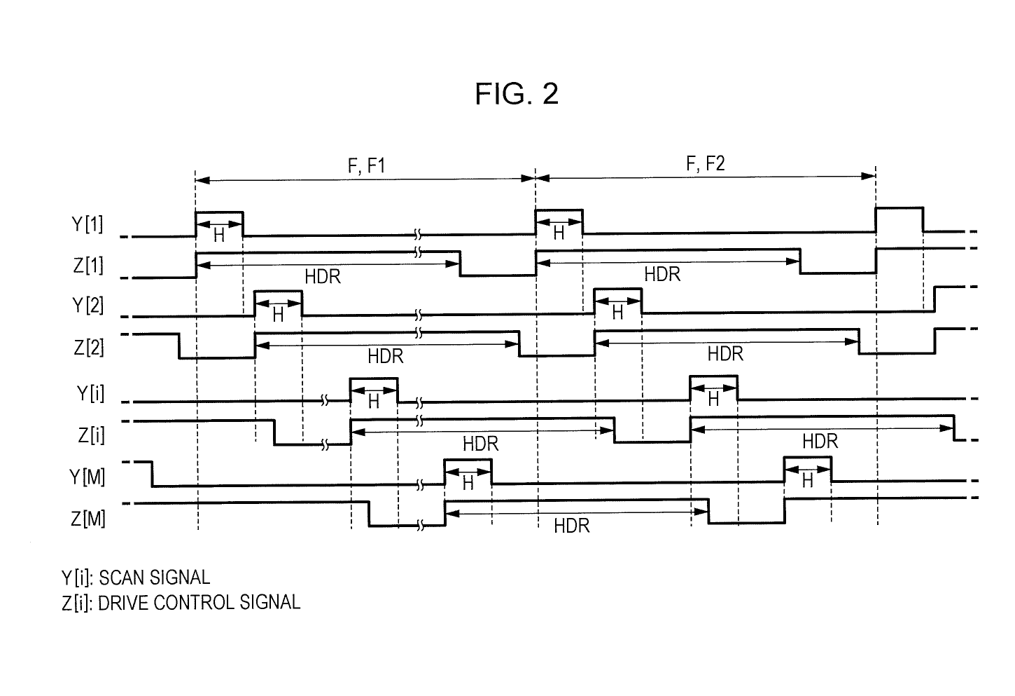

FIG. 2 illustrates a time chart of a wave form of each part of the light emitting device 100. As illustrated in FIG. 2, the scan signal Y[i] supplied to the scan line 12 of the i-th (i=1 to M) row is at a high level during the i-th writing period (horizontal scan period) H in one frame period F (F1, F2, . . . ), and is maintained at a low level during other periods. The scan line drive circuit 22 generates the scan signals Y[1] to Y[M] by sequentially shifting a start pulse SP1 which is at a H level only during one horizontal scan period, by using a clock signal HCK that is synchronized with the horizontal synchronization signal HSYNC. The start pulse SP1 and the clock signal HCK are supplied to the scan line drive circuit 22 from the control circuit 36.

The drive control circuit 24 in FIG. 1 generates the drive control signals Z[1] to Z[M] and outputs the generated drive control signals to each drive control line 14. As illustrated in FIG. 2, the drive control signal Z[i] supplied to the i-th row of drive control line 14 is maintained at a high level during a period of a predetermined time length (hereinafter, referred to as “light emitting period”) HDR from a start point of a writing period H at which the scan signal Y[i] is at a high level to the elapse of the writing period H (before the start of the next writing period H), and is at a low level during other periods.

The drive control circuit 24 generates the drive control signals Z[1] to Z[M] by shifting a start pulse SP2 which is at a H level during the light emitting period HDR by using the clock signal HCK. The start pulse SP2 and the clock signal HCK are supplied to the drive control circuit 24 from the control circuit 36.

The data line drive circuit 26 in FIG. 1 generates the data signals X[1] to X[N] based on gradation data GD for designating the gradation of each pixel circuit P and outputs the generated data signals to each data line 16. Each data signal X[j] (j=1 to N) is a voltage VDATA corresponding to the gradation data GD of the pixel circuit P of the j-th column belonging to the i-th row. The gradation data GD, a dot clock signal DCK, the clock signal HCK are supplied to the data line drive circuit 26 from the control circuit 36. The control circuit 36 generates various control signals, and supplies the control signals to the scan line drive circuit 22, the drive control circuit 24, and the data line drive circuit 26.

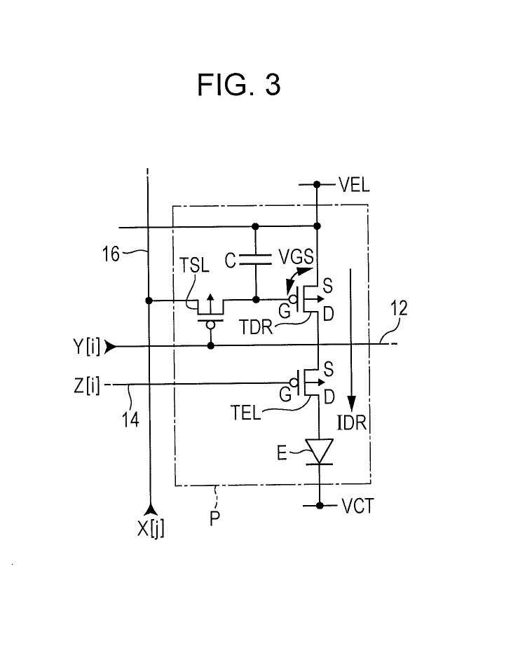

FIG. 3 is a circuit diagram illustrating an example of a pixel circuit included in the light emitting device 100. Here, the specific configuration of each pixel circuit P will be described with reference to FIG. 3. Further, only one pixel circuit P of the j-th column belonging to the i-th row is representatively illustrated in FIG. 3.

As illustrated in FIG. 3, the pixel circuit P includes a light emitting element E. The light emitting element E of the present embodiment is an organic light emitting diode element in which a light emitting layer made of an organic Electro-Luminescence (EL) material is interposed between an anode and a cathode facing each other. The light emitting element E emits light with intensity according to the current amount of a drive current IDR supplied to the light emitting layer. The cathode of the light emitting element E is electrically connected to a power (ground potential) VCT on a low side.

A P-channel type drive transistor TDR is arranged on a path of the drive current IDR (between a power VEL on a high side and the anode of the light emitting element E). The drive transistor TDR corresponds to a unit that controls the current amount of the drive current IDR according to the gate-source voltage VGS. The source (indicated by S in FIG. 3) of the drive transistor TDR is connected to the power VEL on the high side.

A capacitor C is interposed between the gate and the source (power VEL) of the drive transistor TDR. Further, a P channel type selection transistor TSL is disposed between the gate of the drive transistor TDR and the data line 16. The selection transistor TSL is a switching element for controlling the electrical connection (conduction/non-conduction) between the gate of the drive transistor TDR and the data line 16. The gate of the selection transistor TSL of each pixel circuit P belonging to the i-th row is connected to the i-th row scan line 12.

A P channel type drive control transistor TEL is disposed between the drain D of the drive transistor TDR and the anode of the light emitting element E (that is, on the path of the drive current IDR). The drive control transistor TEL is a switching element for controlling the electrical connection between the drain D of the drive transistor TDR and the anode of the light emitting element E. After the path of the drive current IDR is established by the drive control transistor TEL being conducted, the drive control transistor TEL functions as a unit that controls the availability of the supply of the drive current IDR for the light emitting element E. The gate of the drive control transistor TEL of each pixel circuit P belonging to the i-th row is connected in common to the drive control line 14 of the i-th row.

In the above configuration, as illustrated in FIG. 2, the scan signal Y[i] is shifted to a high level (that is, if the scan line 12 of the i-th row is selected), the selection transistor TSL is conducted. Accordingly, if the scan signal Y[i] is shifted to a high level within the writing period H, the potential VDATA of the data signal X[j] is supplied to the gate of the drive transistor TDR through the selection transistor TSL, and electric charges corresponding to the potential VDATA is accumulated in the capacitor C. In other words, the potential VG of the gate of the drive transistor TDR is set to a potential VDATA corresponding to the gradation data GD.

If the scan signal Y[i] is shifted to a low level at the end of the writing period H, the selection transistor TSL is in a non-conductive state and the gate of the drive transistor TDR is electrically isolated from the data line 16, but the potential VG of the gate of the drive transistor TDR is maintained at a potential VDATA by the capacitor C even after the elapse of the writing period H.

Since the drive control Z[i] is shifted to a high level, the drive control transistor TEL is conducted from the start of the writing period H. Accordingly, in a light emitting period HDR including a writing period H, the drive current IDR of the current amount corresponding to the potential VG (potential VDATA) of the gate of the drive transistor TDR is supplied to the light emitting element E through the drive transistor TDR and the drive control transistor TEL from the power VEL. The light emitting element E emits light with an intensity according to the current amount of the drive current IDR (that is, an intensity according to the potential VDATA). The current amount of the drive current IDR is determined depending on the size of the gate-source voltage VGS of the drive transistor TDR.

Here, an active layer of at least the drive transistor TDR is manufactured of a crystalline material. The active layer is a region provided between the source and the drain of the drive transistor TDR, is disposed facing the gate, and the conductivity is controlled by the potential of the gate. Examples of the crystalline material may include single-crystal silicon, or poly silicon of which crystallinity is enhanced by a Selectively Enlarging Laser X'tallization (SELAX) method. The SELAX method is a technology of forming “pseudo single′crystal silicon” by melting and solidifying a thin silicon film under an optimum condition by irradiating the poly silicon with a solid-state laser while controlling the pulse width of the laser.

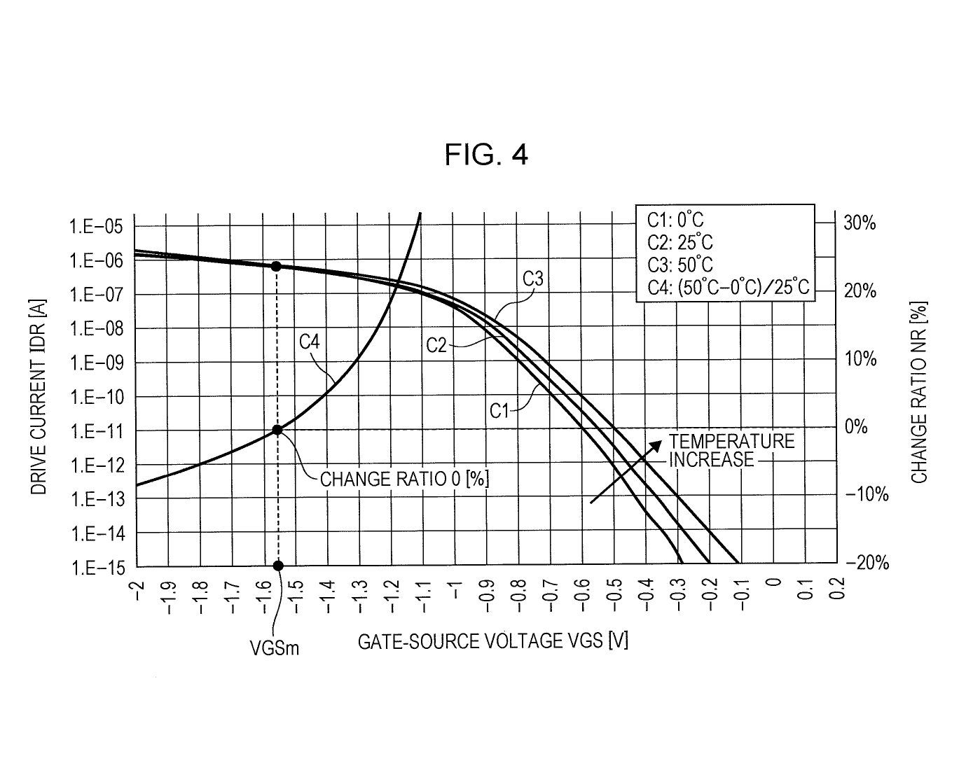

FIG. 4 is a diagram illustrating a characteristic curve representing a relationship between a gate-source voltage VGS of the drive transistor TDR and the drive current IDR, and a curve representing a relationship between a gate-source voltage VGS of the drive transistor TDR and the change ratio (change rate) of the drive current IDR due to a change in environmental temperature.

In FIG. 4, the characteristic curve C1 is a characteristic curve when the environmental temperature is 0[° C.], the characteristic curve C2 is a characteristic curve when the environmental temperature is 25[° C.], and the characteristic curve C3 is a characteristic curve when the environmental temperature is 50[° C.]. As illustrated in FIG. 4, if the environmental temperature changes, the current amount of the drive current IDR flowing by the same gate-source voltage VGS also changes.

Here, the characteristic curve C4 illustrated in FIG. 4 is a curve representing a relationship between a gate-source voltage VGS of the drive transistor TDR and the change ratio NR of the drive current IDR due to the environmental temperature change. Here, the change ratio NR is calculated by the following Equation (1).

NR=(I3−I1)/I2 (Equation 1)

In Equation 1, I1 is a value of the drive current IDR when the environmental temperature is 0[° C.], I2 is a value of the drive current IDR when the environmental temperature is 25[° C.], I3 is a value of the drive current IDR when the environmental temperature is 50[° C.], and NR is a change ratio [%].

Here, the change ratio NR is an index indicating a change rate of the drive current IDR with respect to the environmental temperature change. The greater the value of the change ratio NR the gate-source voltage VGS has, the greater the change in the drive current IDR with respect to the environmental temperature change is. Meanwhile, the smaller the value of the change ratio NR the gate-source voltage VGS has, the smaller the change in the drive current IDR with respect to the environmental temperature change is.

Here, the gate-source voltage VGS when the change ratio NR is equal to or less than a predetermined value (in the present embodiment, 0[%] which is a minimum value) is referred to as a “change minimum voltage VGSm”. In the example illustrated in FIG. 4, the value of the change minimum voltage VGSm is −1.55 [V]. The value of the change minimum voltage VGSm mainly depends on the thickness of a gate oxide film of the drive transistor TDR.

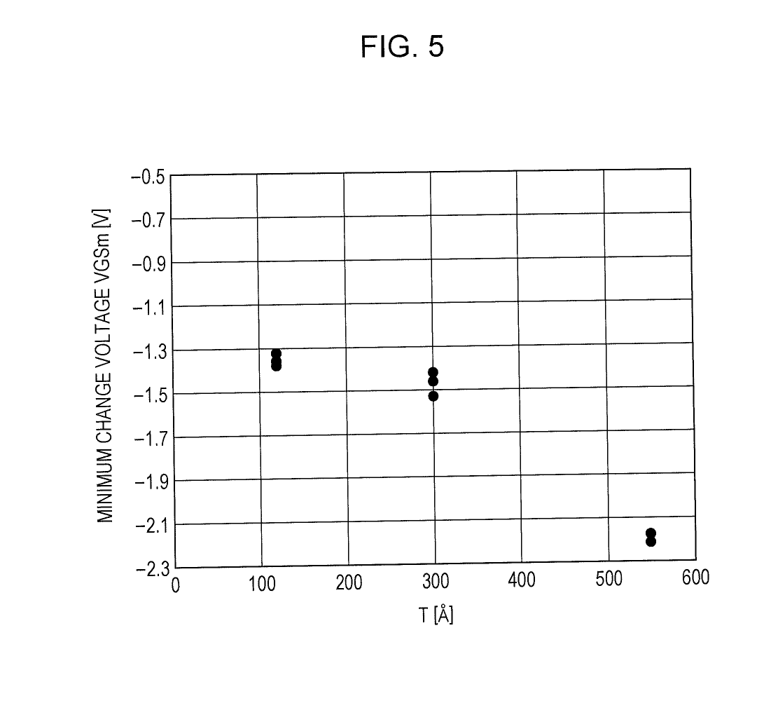

FIG. 5 is a diagram illustrating an example of a relationship between the thickness [angstrom] of the gate oxide film and the change minimum voltage VGSm. As illustrated in FIG. 5, when the thickness [angstrom] of the gate oxide film of the drive transistor TDR is 100 [angstrom], the change minimum voltage VGSm is −1.3 to −1.4 [V] or so, when the thickness [angstrom] of the gate oxide film is 300 [angstrom], the change minimum voltage VGSm is −1.4 to −1.55 [V] or so, when the thickness [angstrom] 550 [angstrom], the change minimum voltage VGSm is −2.2 [V] or so.

In addition, the value of the change minimum voltage VGSm varies with respect to the same thickness of the gate oxide film [angstrom] because of a ratio (W/L) of the channel width (W) and the channel length (L) of the drive transistor TDR.

In the present embodiment, the thickness [angstrom] of the gate oxide film of the drive transistor TDR is about 300 [angstrom], and the change minimum voltage VGSm is about −1.55[V], as illustrated in FIG. 4. In addition, naturally, when the drive transistor TDR is an N-type transistor, the positive and the negative of the change minimum voltage VGSm are opposite, and thus the change minimum voltage VGSm is about 1.55 [V].

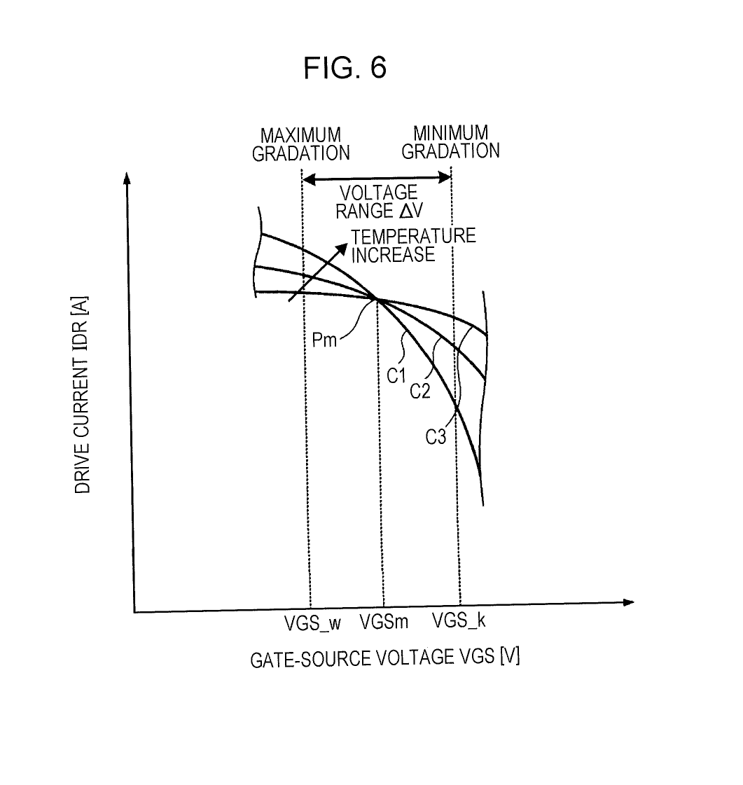

FIG. 6 is a diagram illustrating an enlarged view of the vicinity of an intersection (hereinafter, referred to as “change minimum point Pm”) of characteristic curves C1, C2, and C3 in the graph illustrated in FIG. 4. The voltage range ΔV illustrated in FIG. 6 represents a range of the gate-source voltage VGS applied to the drive transistor TDR. Specifically, the voltage range ΔV is defined as a range between a first voltage value VGS_k at which the light emitting element E emits light at a luminance corresponding to a first gradation (here, minimum gradation) and a second voltage value VGS_w at which the light emitting element E emits light at a luminance corresponding to a second gradation (here, maximum gradation). The width of the voltage range ΔV is determined by a specification and the like of the light emitting device 100.

As described above, since the drive transistor TDR is made of a crystalline material, such as, for example, single-crystal silicon, or poly silicon of which crystallinity is enhanced by a SELAX method, a characteristic curve representing a voltage-current characteristic at a time of a specific environmental temperature (first temperature) and a characteristic curve representing a voltage-current characteristic at a time of an environmental temperature (second temperature) different from the first temperature intersect with each other, in the drive transistor TDR.

In other words, substantially the same drain current can be obtained, regardless of the environmental temperature, at a specific gate-source voltage VGS. That is because the drive transistor which is a semiconductor device has two different characteristic areas in which the characteristics of the current change with respect to the environmental temperature change are different from each other with the specific gate-source voltage as a reference. One characteristic area out of the two characteristic areas is a first characteristic area in which the current increases with the increase of the environmental temperature and the other characteristic area is a second characteristic area in which the current decreases with the increase of the environmental temperature.

Further, in the transistor formed on a semiconductor substrate made of a crystalline material other than the crystalline material described above, a characteristic curve representing a voltage-current characteristic at a time of a first temperature and a characteristic curve representing a voltage-current characteristic at a time of a second temperature which is different from the first temperature do not intersect with each other.

The voltage range ΔV which is defined by a first voltage value at which the light emitting element E emits light at a luminance corresponding to a minimum gradation and a second voltage value at which the light emitting element E emits light at a luminance corresponding to a maximum gradation is set so as to include the value of the change minimum voltage VGSm as illustrated in FIG. 6. In other words, the data line drive circuit 26 generates the data signals X[1] to X[N] such that the voltage range ΔV includes the value of the change minimum voltage VGSm, and outputs the generated data signals to the respective data lines 16.

A constant drive current IDR can be obtained by the change minimum voltage VGSm, regardless of the environmental temperature change, and as the gate-source voltage is closer to the change minimum voltage VGSm, the change in the drive current IDR due to the environmental temperature change is small, but the first voltage value and the second voltage value (voltage range ΔV) are set so as to include the change minimum voltage VGSm, and thus the change in the drive current IDR due to the environmental temperature change is significantly suppressed and the change in the light emission luminance is significantly suppressed.

Here, the first voltage value and the second voltage value (voltage range ΔV) are set such that the center value (a voltage value at which the light emitting element E emits light at a luminance corresponding to an intermediate gradation between the minimum gradation and the maximum gradation) of the voltage range ΔV is the value (in the embodiment, −1.55 [V]) of the change minimum voltage VGSm as illustrated in FIG. 6. For example, in a case of causing the light emitting element E to emit light at 256 gradations of gradation levels 0 to 255, the first voltage value and the second voltage value (voltage range ΔV) are set such that a voltage value at which the light emitting element E emits light at a luminance corresponding to a gradation level 128 is the value (in the embodiment, −1.55 [V]) of the change minimum voltage VGSm. By setting in this manner, even when the environmental temperature changes, variation is hardly generated in the luminance corresponding to the intermediate gradation between the minimum gradation and the maximum gradation, and thus visibility is greatly improved.

Further, the setting mode of the first voltage value and the second voltage value (voltage range ΔV) is not limited to the example described above, but for example, may be set as follows.

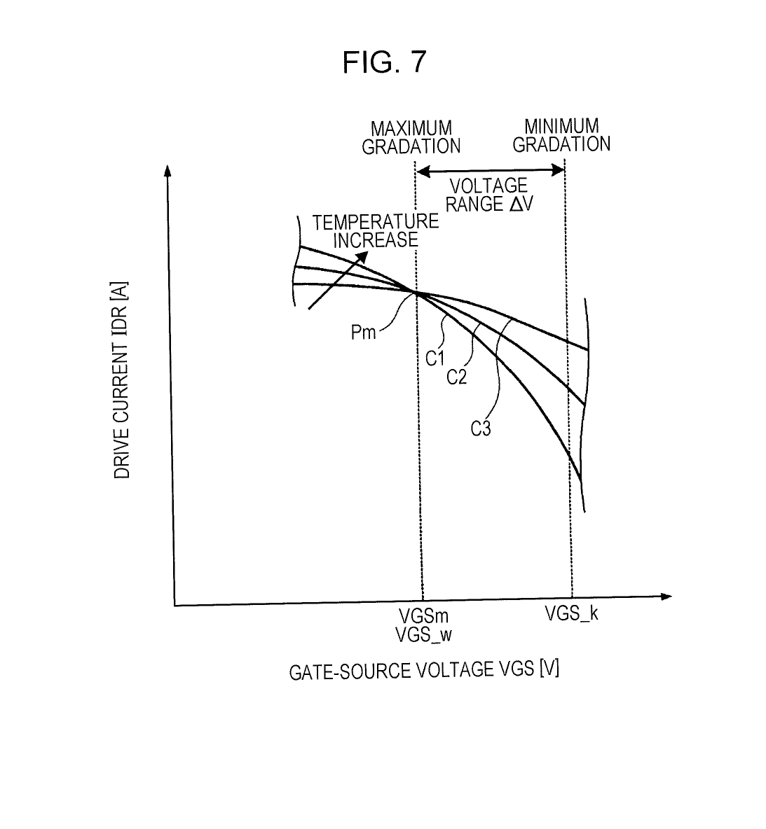

FIG. 7 is a diagram illustrating a modification example of the setting mode of the first voltage value and the second voltage value (voltage range ΔV). As illustrated in FIG. 7, the first voltage value and the second voltage value (voltage range ΔV) may be set such that the second voltage value at which the light emitting element E emits light at the luminance corresponding to the maximum gradation is the value (in the embodiment, −1.55 [V]) of the change minimum voltage VGSm. In other words, the first voltage value and the second voltage value (voltage range ΔV) may be set such that VGS_w=VGSm. For example, in a case of causing the light emitting element E to emit light at 256 gradations of gradation levels 0 to 255, the first voltage value and the second voltage value (voltage range ΔV) is set such that the voltage value at which the light emitting element E emits light at a luminance corresponding to the gradation level 256 is the value (in the embodiment, −1.55 [V]) of the change minimum voltage VGSm. By setting in this manner, even when the environmental temperature changes, variation is hardly generated in the luminance corresponding to the maximum gradation, and thus visibility is greatly improved.

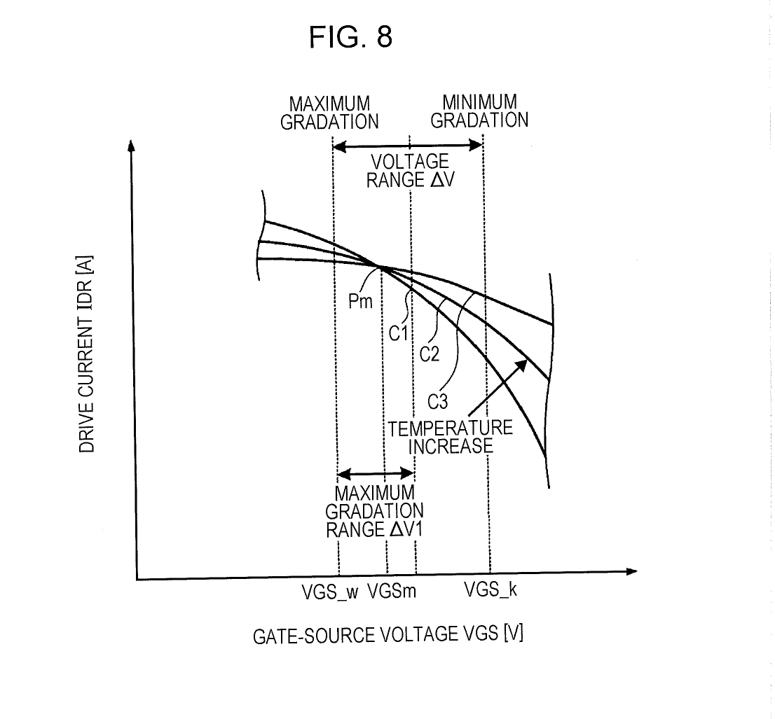

FIG. 8 is a diagram illustrating a modification example of the setting mode of the first voltage value and the second voltage value (voltage range ΔV). The light emission at a luminance corresponding to the maximum gradation is further easily visible to a user as compared to the light emission at a luminance corresponding to the minimum gradation. Therefore, it is preferable that the change in the light emission luminance corresponding to the maximum gradation or the gradation level of the vicinity thereof with respect to the environmental temperature change be small. In view of this, the voltage value corresponding to an intermediate gradation level of the voltage range ΔV may be set to a reference voltage level, and the first voltage value and the second voltage value (voltage range ΔV) may be set such that the change minimum voltage VGSm is included in the range (“high gradation range ΔV1” illustrated in FIG. 8) on the side of the voltage value corresponding to the maximum gradation with respect to the reference voltage level. Thus, even if the environmental temperature changes, the variation is hardly generated in the luminance at which the user's visibility is good, and the visibility is greatly improved.

As described above, according to the embodiment of the invention, it is possible to provide a light emitting device, an electronic apparatus, and a design method of a semiconductor device, in which the light emission luminance change due to the environmental temperature change is suppressed. In addition, the change minimum voltage VGSm (third voltage value) is not necessarily the gate-source voltage VGS when the change ratio NR is 0[%], but may be the gate-source voltage VGS when the value of the change ratio NR is relatively small (for example, a value in the vicinity of 0[%].

### B: Modification Example

It is possible to add various modifications to the respective embodiments described above. The embodiments of the specific modifications are as follows. In addition, the following respective embodiments may be appropriately combined.

### (1) Modification Example 1

Although the configuration in which the drive control transistor TEL is conducted simultaneously with the start of the writing period H in the above embodiments are illustrated, a time at which the drive control transistor TEL is conducted (in other words, a time at which the drive control signal Z[i] is set to a high level) is appropriately changed. For example, the drive control transistor TEL may be conducted from a time before or after the start of the writing period H. Further, the drive control transistor TEL may be conducted from a time after the writing period H. Furthermore, the light emitting period HDR may be initiated after a predetermined time has elapsed since the writing period H is completed, and may be terminated immediately before the next writing period H.

The configuration of the pixel circuit is changed appropriately. For example, as disclosed in JP-A-2005-099773, it is possible to interpose a capacitor between the selection transistor and the drive transistor. It is possible to set the gate-source voltage of the drive transistor according to the designated gradation, by changing the potential of the data line by the change amount corresponding to the designated gradation, and by changing the potential of the gate of the drive transistor according to the change amount of the potential of the data line by using the capacitive coupling of the capacitors. In other words, the potential of the gate does not always match the potential of the data line.

### (2) Modification Example 2

The conductivities of the respective transistors constituting the pixel circuit P may be appropriately changed. For example, the drive transistor TDR may be an N-channel type. In other words, it is possible to employ a configuration in which the drive control transistor TEL is interposed between the source of the N-channel type drive transistor TDR and the cathode of the light emitting element E.

### (3) Modification Example 3

The organic light emitting diode element is merely illustrative of the electro-optical device. The electro-optical device applied to the invention may be any type as long as it is a self-luminous type that emits light itself, and corresponds to, for example, an inorganic EL element, or a Light Emitting Diode (LED) element, and the like.

### C: Application Example

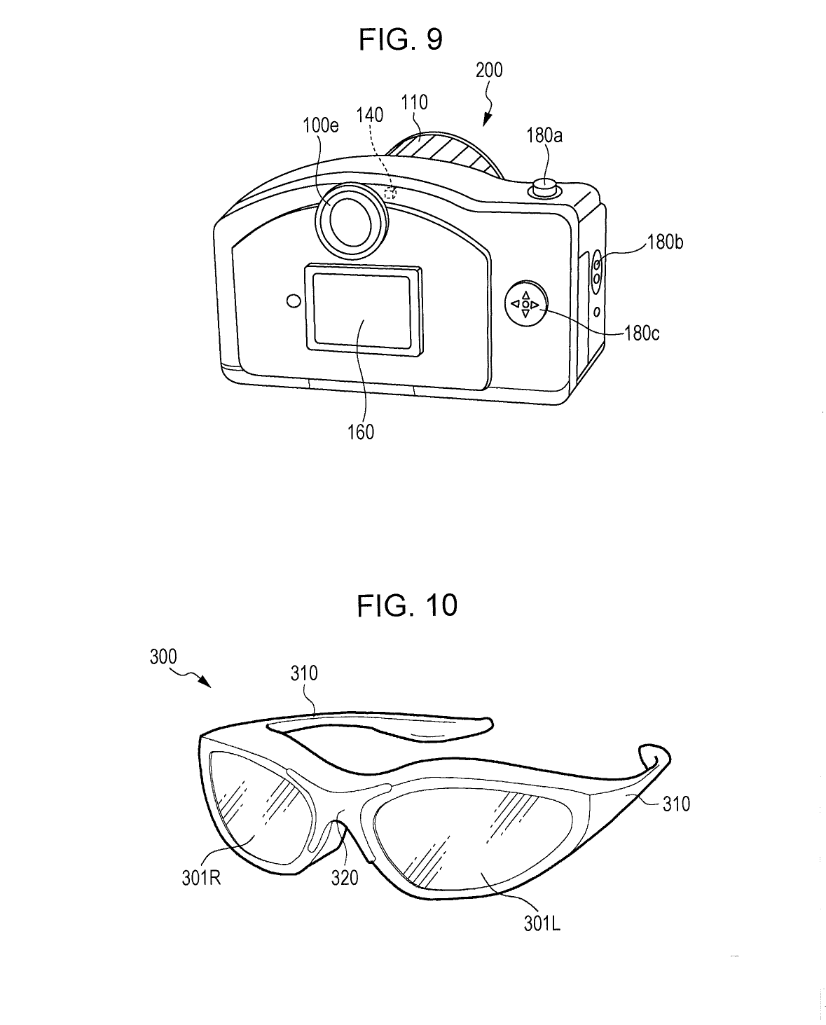

Next, an electronic apparatus using the light emitting device according to the invention will be described. FIG. 9 to FIG. 12 illustrate forms of electronic apparatuses employing the light emitting device 100 according to any of aspects described above as the display device.

FIG. 9 is an external diagram illustrating a configuration example of a digital camera. The light emitting device 100 according to the embodiment of the invention can be applied to a digital camera including, for example, a peep type Electronic View Finder (EVF). As illustrated in FIG. 9, a digital camera 200 includes a lens 110, a display unit 160, a release button 180a, a power button 180b, a cursor button/enter button 180c, a sensor 140 for peep-sensing the EVF, an EVF 100e, and the like. Here, the EVF 100e includes a light emitting device including an EVF image display unit and a drive control unit for driving the EVF image display unit. The light emitting device 100 according to the invention is applied to the light emitting device.

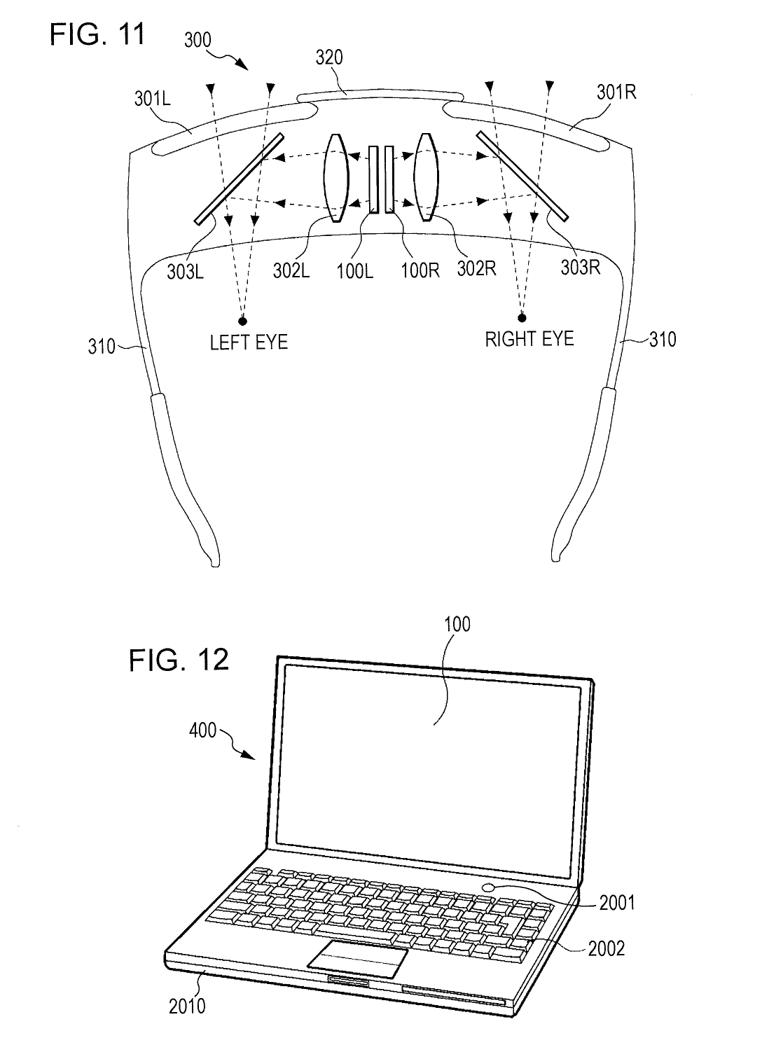

FIG. 10 is a diagram illustrating an appearance of a head mounted display, and FIG. 11 is a diagram illustrating an optical configuration thereof. The light emitting device 100 according to embodiments of the invention can be applied to, for example, a head mounted display. Further, as illustrated in FIG. 10, the head mounted display 300 includes a temple 310, a bridge 320, and lens 301L and 301R, similarly to general glasses. Further, as illustrated in FIG. 11, in a head mounted display 300, a light emitting device 100L for the left eye and a light emitting device 100R for the right eye are provided in the vicinity of the bridge 320 and the rear side (lower side in FIG. 11) of the lenses 301L and 301R. The image display surface of the light emitting device 100L is arranged to be left in FIG. 11. Thus, the display image by the light emitting device 100L emits light through the optical lens 302L in the 9 o'clock direction in FIG. 11. A half mirror 303L reflects the display image by the light emitting device 100L in the 6 o'clock direction, and transmits the light incident from the 12 o'clock direction. The image display surface of the light emitting device 100R is arranged to be right opposite to that of the light emitting device 100L. Thus, the display image by the light emitting device 100R emits light through the optical lens 302R in the 3 o'clock direction in FIG. 11. A half mirror 303R reflects the display image by the light emitting device 100R in the 6 o'clock direction, and transmits the light incident from the 12 o'clock direction.

In the configuration, a wearer of the head mounted display 300 can observe the display images by the light emitting devices 100L, 100R in a see-through state in which the display images are overlapped with the outer appearance. Further, in the head mounted display 300, if the left eye image out of binocular image with parallax is displayed on the light emitting device 100L and the right eye image thereof is displayed on the light emitting device 100R, this allows the wearer to perceive the displayed image as if it has a depth and a stereoscopic effect (3D display).

FIG. 12 is a perspective view illustrating an appearance of a mobile type personal computer employing the light emitting device 100. A personal computer 400 includes a light emitting device 100 that displays various images, and a main body unit 2010 in which a power switch 2001 and a keyboard 2002 are mounted. The light emitting device 100 uses an organic light emitting diode element as the light emitting element E, and can thus display an easily viewable screen with a wide viewing angle. The personal computer 2000 is configured such that a surface for displaying an image of the light emitting device 100 is foldable toward the keyboard. Then, a lighting control signal CTL, which is at a L level in a folded state and is at a H level in an open state, is supplied from the main body to the light emitting device 100.

In addition, examples of the electronic apparatus, to which the light emitting device according to the invention is applied, include apparatuses equipped with televisions, video cameras, car navigation devices, pagers, electronic organizes, electronic papers, calculators, word processors, workstations, video phones, POS terminals, printers, scanners, copiers, video player, and touch panels, in addition to the apparatuses illustrated in FIG. 9 to FIG. 12.

The entire disclosure of Japanese Patent Application No. 2013-211673, filed Oct. 9, 2013 is expressly incorporated by reference herein.

What is claimed is:

1. A light emitting device comprising:
a drive transistor that generates a drive current of a current amount corresponding to a gate-source voltage;
a light emitting element that emits light at a luminance corresponding to the current amount of the drive current; and
a control unit that controls the gate-source voltage according to a specified gradation,
wherein the gate-source voltage is a first voltage value or more at which the light emitting element emits light at a luminance corresponding to a first gradation and a second voltage value or less at which the light emitting element emits light at a luminance corresponding to a second gradation, and
wherein the first voltage value and the second voltage value are set such that a third voltage value, which is a gate-source voltage when a change rate of the drive current with respect to an environmental temperature change is a predetermined value or less, is included between the first voltage value and the second voltage value.

2. The light emitting device according to claim 1,
wherein the third voltage value is the gate-source voltage when the change rate is at a minimum.

3. The light emitting device according to claim 1,
wherein the drive transistor is formed of single crystal silicon or pseudo single crystal silicon.

4. The light emitting device according to claim 1,
wherein the first voltage value and the second voltage value are set such that the third voltage value is a voltage value at which the light emitting element emits light at a luminance corresponding to an intermediate gradation between the first gradation and the second gradation.

5. The light emitting device according to claim 1,
wherein the first voltage value and the second voltage value are set such that the third voltage value is a voltage value at which the light emitting element emits light at a luminance corresponding to a maximum gradation.

6. The light emitting device according to claim 1,
wherein the drive transistor is a P-type transistor, and a thickness of a gate oxide film is 10 nm or more and 30 nm or less, and
wherein the first voltage value and the second voltage value are set such that the third voltage value is a voltage value of −1.55 V or more and −1.3 V or less.

7. The light emitting device according to claim 1,
wherein the drive transistor is an N-type transistor, and a thickness of a gate oxide film is 10 nm or more and 30 nm or less, and
wherein the first voltage value and the second voltage value are set such that the third voltage value is a voltage value of 1.3 V or more and 1.55 V or less.

8. An electronic apparatus comprising:
the light emitting device according to claim 1.

9. An electronic apparatus comprising:
the light emitting device according to claim 2.

10. An electronic apparatus comprising:
the light emitting device according to claim 3.

11. An electronic apparatus comprising:
the light emitting device according to claim 4.

12. An electronic apparatus comprising:
the light emitting device according to claim 5.

13. An electronic apparatus comprising:
the light emitting device according to claim 6.

14. An electronic apparatus comprising:
the light emitting device according to claim 7.

15. A design method of a semiconductor device including a drive transistor that generates a drive current of a current amount corresponding to a gate-source voltage, a light emitting element that emits light at a luminance corresponding to the current amount of the drive current, and a control unit that controls the gate-source voltage according to a specified gradation, the method comprising:
specifying a characteristic when an environmental temperature is a first temperature;
specifying the characteristic when the environmental temperature is a second temperature;
specifying a third voltage value which is a gate-source voltage when a change rate of the drive current with respect to an environmental temperature change is a predetermined value or less, based on the characteristic at a time of the first temperature and the characteristic at a time of the second temperature; and
setting a first voltage value and a second voltage value such that the third voltage value is included between the first voltage value which is the gate-source voltage at which the light emitting element emits light at a luminance corresponding to a minimum gradation and the second voltage value which is the gate-source voltage at which the light emitting element emits light at a luminance corresponding to a maximum gradation.
